(19) United States
(12) Patent Application Publication
(10) Pub. No.: US 2026/0280700 A1
(43) Pub. Date: Sep. 17, 2026

(54) RESOURCE UTILIZATION MONITORING FOR OPTICAL TRANSPORT NETWORKS

(71) Applicant: Nokia Solutions and Networks Oy, Espoo (FI)

(72) Inventors: Mijail Szczerban Gonzalez, Murray Hill, NJ (US); Predrag Dragovic, Murray Hill, NJ (US)

(21) Appl. No.: 19/081,107

(22) Filed: Mar. 17, 2025

(51) Int. Cl. H04B 10/079; H04J 3/16

(52) U.S. Cl. CPC H04B 10/0795; H04J 3/1652

(57) ABSTRACT

Methods and systems for tracking utilization of a resource of an optical transport network by established end-to-end connections include configuring a network element to obtain one or more utilization metrics for utilization of the resource by one or more input data streams, and transmitting the utilization metrics to at least one of a network management system (NMS) of the optical network or another network element. In some implementations, the methods and systems may include performing resource usage measurements. In some implementations, the utilization metrics may be transmitted to another network element in overheads of digital containers encapsulating the one or more input data streams.

### TECHNICAL FIELD

The present disclosure generally relates to optical communication networks, and more particularly relates to network resource management and monitoring in optical communication networks.

### BACKGROUND

Modern optical communication networks typically use Optical Transport Network (OTN) protocols to standardize how various client-generated signals may be delivered over fiber-optic networks using wavelength-division multiplexing (WDM) technology and circuit switching. OTN systems establish end-to-end connections between access points in a mesh optical network in a manner that allows end-to-end preservation of the structure of clients' signals, including timing and management information. In a physical layer, an OTN system includes a plurality of optical network elements (NE), such as access nodes and switches, interconnected by WDM links. In a digital layer, OTN uses digital wrapper technology to “wrap” various client signals and different types of traffic, including IP, Ethernet, storage, digital video, and SONET/SDH, into a container, or a set of nested containers or frames. OTN wrapping also supports the use of forward error correction (FEC) to reduce the number of signal regeneration points in the network.

### SUMMARY

An aspect of the present disclosure relates to a method for an optical network. The method comprises: receiving, by a first network element (NE) of the optical network, at least one input data stream; obtaining, by the first NE, at least one first utilization metric for utilization of a resource by the at least one input data stream; transmitting an output data stream from the first NE to a second NE of the optical network over an optical channel, the output data stream comprising the at least one input data stream; and transmitting, from the first NE, the at least one first utilization metric to at least one of a network management system (NMS) of the optical network or the second NE.

Some implementations of the method may comprise transmitting, from the first NE, the at least one first utilization metric in an overhead of at least one first digital container encapsulating the at least one input data stream. Some implementations of the method may comprise transmitting the at least one first utilization metric to the NMS over a digital communications network.

Any of the above implementations may comprise computing a second utilization metric for the output data stream based at least in part on the at least one first utilization metric, and transmitting the second utilization metric to at least one of the NMS of the optical network or the second NE. Any such implementation may comprise transmitting the second utilization metric in an overhead of a higher-order (HO) digital container encapsulating the at least one first digital container.

In any of the above implementations, the at least one input data stream may comprise a plurality of input data streams, the output data stream may comprise an aggregation of the plurality of input data streams, and the method may comprise obtaining a plurality of first utilization metrics for the plurality of input data streams. Some implementations may comprise transmitting the plurality of first utilization metrics in overheads of first digital containers encapsulating corresponding ones of the plurality of input data streams. Some implementations may comprise computing the second utilization metric based on the plurality of first utilization metrics. Some implementations may further comprise transmitting the second utilization metric in an overhead of a higher-order (HO) digital container encapsulating the first digital containers.

Any implementation of the method comprising transmitting, from the first NE, the plurality of first utilization metrics over the optical channel in overheads of first digital containers encapsulating corresponding ones of the plurality of input data streams may further comprise: encapsulating, at the second NE, a subset of the first digital containers received over the optical channel from the first NE, for transmitting to a third NE of the optical network in a higher-order (HO) digital container; computing a third utilization metric based on a subset of the first utilization metrics read from the overheads of the subset of the first digital containers; and transmitting the third utilization metric in an overhead of the HO digital container encapsulating the subset of the first digital containers.

In any of the above implementations, obtaining the at least one first utilization metric may comprise performing resource usage measurements at the first NE. In some implementations, performing the resource usage measurements at the first NE may comprise measuring at least one of: a data rate of the at least one input data stream, electrical power usage at the first NE, or processor memory usage at the first NE. The first utilization metric may comprise an estimate of a physical resource or a logical resource provided by the first NE to process the at least one input data stream.

In any of the above implementations, the first NE can include a first interface comprising at least one port for receiving the at least one input data stream. The method may include periodically measuring a data rate of the at least one input data stream to obtain a stream data rate metric. In some implementations, the method may further comprise computing a ratio of the stream data rate metric to a data rate capacity of the port of the first interface receiving the at least one input data stream to estimate the first utilization metric.

In any of the above implementations of the method, the optical network may be a connection-switched optical network, and the method may comprise collecting, by the NMS, a plurality of first utilization metrics from a plurality of NEs of the optical network to estimate end-to-end utilization of the resource by the at least one input data stream.

A related aspect of the present disclosure provides a system comprising a first network element (NE) of an optical network. The first NE comprises a first interface configured to receive at least one input data stream, a second interface configured to transmit an output data stream over an optical channel, the output data stream comprising the at least one input data stream, and digital hardware configured to obtain at least one first utilization metric for the at least one input data stream. The first NE is configured to transmit the at least one first utilization metric to at least one of a network management system (NMS) of the optical network or a second NE of the optical network.

In some implementations, the digital hardware may be configured to perform measurements of a resource to obtain the at least one first utilization metric. In some implementations, the digital hardware may receive the at least one first utilization metric with the at least one input data stream. In some implementations, the digital hardware may generate the at least one first utilization metric based on a pre-defined policy.

In any of the above implementations of the system, the first NE may be configured to transmit the at least one first utilization metric comprised in a least one first digital container encapsulating the at least one input data stream.

In any of the above implementations of the system, the at least one input data stream may comprise a plurality of input data streams, the output data stream may comprise an aggregation of the plurality of input data streams, and the at least one first utilization metric may comprise a plurality of first utilization metrics corresponding to the plurality of input data streams. The first NE may be configured to transmit the plurality of first utilization metrics in overheads of first digital containers encapsulating corresponding ones of the plurality of input data streams. In any such implementation, the system may comprise the second NE. The second NE may be configured to receive the output data stream of the first NE over the optical channel, to demultiplex a subset of the first digital containers from the output data stream received from the first NE, and to encapsulate the demultiplexed subset of the first digital containers into a higher-order (HO) digital container for transmitting to a third NE of the optical network. The second NE may further comprise digital hardware configured to compute a third utilization metric based on first utilization metrics transmitted in the overheads of the demultiplexed subset of first digital containers, and to transmit the third utilization metric in an overhead of the HO digital container encapsulating the demultiplexed subset of the first digital containers.

In any of the above implementations, the digital hardware of the first NE may further be configured to compute, based at least in part on the at least one first utilization metric, a second utilization metric for the output data stream, and to transmit the second utilization metric to at least one of the NMS and the second NE. In any such implementation, the first NE may be configured to transmit the second utilization metric in an overhead of a higher-order (HO) digital container encapsulating the at least one first digital container.

In any of the above implementations, the digital hardware may be configured to perform measurements of a resource to obtain the at least one first utilization metric.

In any of the above implementations the first interface may comprise at least one port for receiving the at least one input data stream. The digital hardware may be configured to perform data rate measurements on the at least one input data stream to obtain the at least one first utilization metric, the at least one first utilization metric being a measure of utilization of a data rate capacity of the at least one port by the at least one input data stream.

In any of the above implementations, the at least one first utilization metric may comprise a ratio of a measure of a data rate of the at least one input data stream to a data rate capacity of a port of the first interface.

An aspect of the present disclosure provides an optical network comprising a plurality of network elements (NEs) interconnected by optical fiber links, and a network management system (NMS) configured to communicate with the NEs over a data communication network (DCN). At least some of the plurality of NEs are configured to perform measurements of a NE resource to estimate utilization of the NE resource by data streams being received and/or transmitted by said NEs to provide an end-to-end connection in the optical network to support a service, and to generate corresponding utilization metrics. The NMS is configured to use the utilization metrics generated at the at least some of the plurality of NEs to estimate an end-to-end utilization of a network resource by the service.

### BRIEF DESCRIPTION OF THE DRAWINGS

Embodiments disclosed herein will be described in greater detail with reference to the accompanying drawings which represent example embodiments thereof, in which like elements are indicated with like reference numerals, and wherein:

FIG. 1 is a schematic block diagram illustrating an OTN frame structure;

FIG. 2 is a schematic diagram of an optical communication network with resource utilization monitoring;

FIG. 3 is a flowchart of a method for network resource utilization tracking;

FIG. 4 is a block diagram of an example terminal NE with resource utilization tracking;

FIG. 5 is a flowchart of a method for network resource utilization tracking at a multiplexing NE;

FIG. 6A is a schematic diagram of a resource utilization descriptor (RUD) field of a digital container overhead;

FIG. 6B is a schematic diagram of a digital container overhead including the RUD field of FIG. 6A;

FIG. 7A is a schematic diagram of a LO digital OTN container with a client signal in the payload;

FIG. 7B is a schematic diagram of a HO digital container including a plurality of multiplexed LO digital containers of FIG. 7A in the payload;

FIGS. 8A-8C are diagrams schematically illustrating used port data rate capacity at four client-side interface ports of a terminal NE according to three different examples;

FIG. 9 is a schematic block diagram of a switching NE;

FIG. 10 is a flowchart of a method for resource utilization tracking at a switching NE;

FIG. 11 is a schematic block diagram of an example network device.

### DETAILED DESCRIPTION

In the following description, for purposes of explanation and not limitation, specific details are set forth, such as particular circuits, circuit components, techniques, etc. in order to provide a thorough understanding of the present disclosure. However, it will be apparent to one skilled in the art that the present disclosure may be practiced in other embodiments that depart from these specific details. In other instances, detailed descriptions of well-known methods, devices, and circuits may be omitted so as not to obscure the description. All statements herein reciting principles, aspects, and embodiments, as well as specific examples thereof, are intended to encompass both structural and functional equivalents thereof. Additionally, it is intended that such equivalents include both currently known equivalents as well as equivalents developed in the future.

Note that, unless explicitly stated, as used herein, the terms “first”, “second” and so forth are not necessarily intended to imply sequential ordering but may rather be intended to distinguish one element from another. Similarly, sequential ordering of method steps does not imply a requirement of sequential order of their execution, unless explicitly stated. The term “connected” may encompass direct connections or indirect connections through intermediate elements, unless explicitly stated otherwise. The term “service” refers to an end-point to end-point network connection requested by a customer to support a data flow (or end-point to several end-points, for broadcast or multicast services); examples of a service include, but are not limited, to network connections provided to customer data flows carrying video and/or audio streaming, IP messaging, VOIP, uploading and/or downloading, etc. The terms “resource utilization” and “service utilization” both refer to utilization of a network resource by a data traffic flow associated with a service, or by an aggregate of such traffic flows, and may be used herein interchangeably. The following abbreviations and acronyms may be used in the present document:
“OTN” Optical Transport Network
“IP” Internet Protocol
“ASIC” Application Specific Integrated Circuit
“FPGA” Field Programmable Gate Array
“WDM” Wavelength Division Multiplexing
“TDM” Time Division Multiplexing
“FEC” Forward Error Correction
“FIFO” First In First Out
“GbE” Gigabit Ethernet
“NE” network element
“NID” Network Interface Device
“UNI” User-to-Network Interface
“ODU” Optical Channel Data Unit
“OPU” Optical Channel Payload Unit
“OTU” Optical Channel Transport Unit
“LO” Lower order
“HO” Higher order
“OH” Overhead
“SDH” Synchronous Digital Hierarchy
“SONET” Synchronous Optical Networking
“UM” Utilization Metric
“RUD” Resource Utilization Descriptor
“OCh” Optical Channel Container
“VOIP” Voice Over Internet Protocol
“STS-x” Synchronous Transport Signal Level-x
“STM-y” Synchronous Transport Module Level-y
“NMS” Network Management System
“DCN” Data Communication Network
“MPDR” Mean Peak Data Rate
“ITU” International Telecommunications Union
“EO” Electrical-to-Optical
“RUE” Resource Utilization Estimator
“SNE” Switching Network Element
“SUE” Switching Utilization Estimator
“MUE” Multiplexing Utilization Estimator
“MAC” Media Access Control
“DSP” Digital Signal Processing
“CPU” Central Processing Unit
“GPU” Graphics Processing Unit

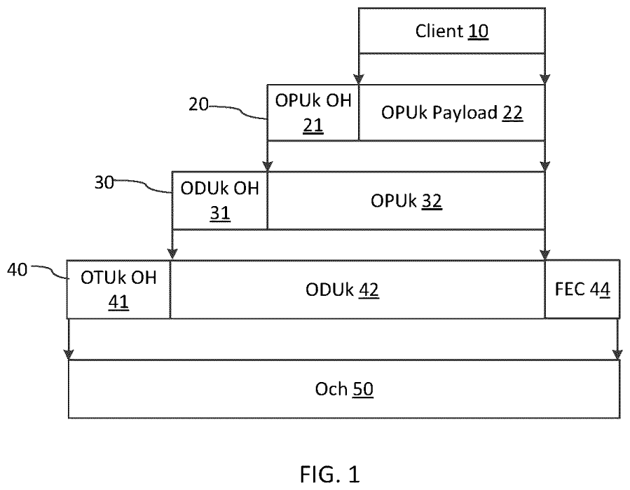

With reference to FIG. 1, in the electrical domain OTN uses a set of nested frames or containers that includes an optical channel payload unit (OPUk) 20, an optical channel data unit (ODUk) 30, and an optical channel transport unit (OTUk) 40. The OPUk 20 (k=0 to 4) encapsulates client signals 10 (e.g. Ethernet, SONET, SDH, etc.) as a payload 22, performs rate justification as needed, and adds an OPUk overhead (OH) 21. The ODUk 30 takes the OPUk 20 as the payload 32 and adds an ODUk OH 31. The ODUk 30 provides end-to-end optical channel performance monitoring of the end-to-end transmission of the service signals in the OTN network. The OTUk 40 (k=0 to 4) takes the ODUk 30 as the payload 42, adds a corresponding overhead OTUk OH 41, and FEC bytes 44 at the tail. The OTUk 40 transmits the service signals between 3R regeneration points in the OTN network, providing the FEC function and OTU performance monitoring. The integer k, typically from 0 to 4, refers to different bitrate capacity values of corresponding units of containers, which are layered for time-domain multiplexing (TDM). The five data rates initially defined in, e.g., the ODU sublayer, are approximately 1.25 Gbps (ODU0), 2.5 Gbps (ODU1), 10 Gbps (ODU2), 40 Gbps (ODU3), and 100 Gbps (ODU4). A lower rate ODUj can be multiplexed into a higher rate ODUk, j<k. The ODU0 frame is suitable for transporting 1000BASE-X signals, such as Gigabit Ethernet (GbE). The ODU1 frames can transport two ODU0 signals or a STS-48/STM-16 signal. The ODU2 frame can transport eight ODU0s or four ODU1s. A modification of the ODU2 frame, the ODU2e, can transport 10 GbE signals. The ODU3 frame can transport 32 ODU0s, or 16 ODU1s, or four ODU2s, or an STS-768/STM-256 signal, or 40 Gigabit Ethernet (40 GbE). The ODU4 frame can transport 80 ODU0s, or 40 ODU1s, or ten ODU2s, or two ODU3s, or a 100 Gigabit Ethernet (100 GbE) signal. In the optical domain, an OTUk is transmitted between OTN access points in an optical channel container OCh 50, typically over one or more optical wavelength. Signals with data rates not matching “standard” OTN rates may be transported using ODUflex frames.

An ODU container transporting an OTN client may be referred to as Lower Order (LO) ODU, or LO ODUj (j can be 0, 1, 2, 2e, 3, 4, or “flex”). An LO ODUj can be either directly mapped into an OTUk (k=j) or first multiplexed into a higher-order (HO) ODUk (k>j) container. An HO ODUk (k can be 1, 2, 2e, 3, or 4) represents the entity transporting a multiplex of LO ODUj tributary signals in its OPUk area.

Various embodiments described below relate to an apparatus, a system, and a corresponding method, for monitoring and/or tracking resource utilization in an optical fiber network. Resource utilization monitoring may include monitoring network equipment client ports and line capacity utilization. Resource utilization monitoring may also include monitoring of utilization of network hardware resources, such as electrical power consumption, signal processing power, and memory allocated for signal processing. In some embodiments, the optical fiber network may be a connection-switched optical transport network (OTN) using digital OTN wrapping to transmit client signals of various formats, e.g. as defined in ITU Recommendations as G709 and G798. OTN systems establish end-to-end connections between client access points of the network using virtual digital containers, such as OTUk, to transport client signals. The containers are typically defined on a grid of line data rates adapted for time domain multiplexing (TDM). Conventional OTN systems typically provision network resources of sufficient capacity to support client services but typically do not track actual utilization of the provisioned network resources by the client services, such as the actual data rate of the client signals in relation to the data rate capacity of the OTN containers transporting those signals through different sections of the optical network. Embodiments of the present disclosure enable a network management system (NMS) of a connection-switched optical network to collect detailed end-to-end resource utilization information along established connections, and to use this information for, e.g., network optimization and cost assessment. Network operators that lease capacity in their systems may use the collected resource utilization information to assess the actual network cost of services they are providing so that a proper pricing policy can be established.

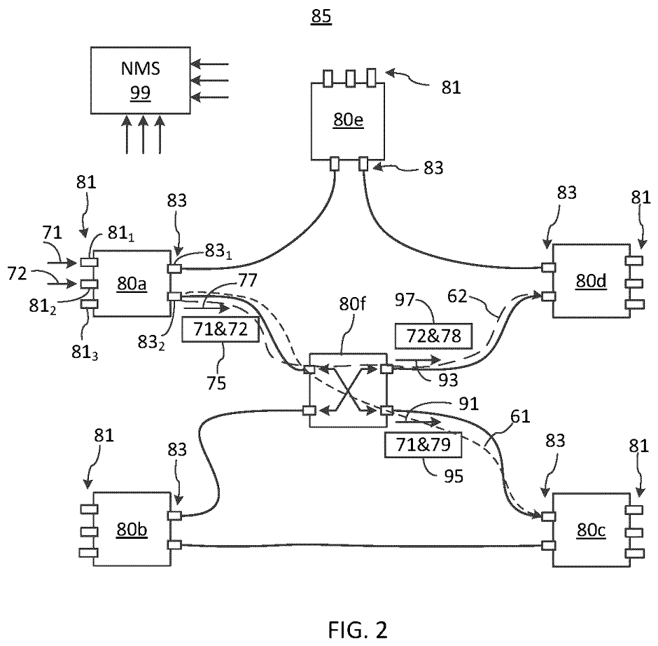

FIG. 2 schematically illustrates an example environment in which embodiments of the present disclosure may be practiced. An optical communication network 85 (“optical network 85”) includes a plurality of network elements (NE) 80a, 80b, 80c, 80d, 80e, and 80f (“NEs 80a-80f”) that are interconnected by optical fiber links indicated with curved solid lines. The NEs 80a-80f may also be communicatively coupled to a network monitoring system (NMS) 99 via a data communication network (DCN) that may be distinct from the optical network 85 (e.g., over the internet). The NEs 80a-80e are points where client signals can enter or exit the optical network 85 and may be referred to herein as the terminal NEs 80a-80e. The NE 80f is a switching or routing NE that is configured to switchably route optical signals along different paths in the network. Each of the terminal NEs 80a-80e includes a client-side interface 81 and a line-side interface 83. The client-side interface 81 typically includes a plurality of client-side ports configured to receive and transmit client data traffic, such as client-side ports 81₁, 81₂, and 81₃ indicated for the NE 80a. The line-side interface 83 includes one or more optical line-side ports, e.g., 83₁ and 83₂ indicated for the NE 80a, which connect to corresponding optical fiber links of the optical network 85. The switching NE 80f is configured to switchably direct client traffic along different routes in the optical network 85. One or more of the terminal NEs 80a-80e may also include switching and/or add/drop capabilities, while the switching NE 80f may include one or more client-side interfaces. The NMS 99 may include one or more computer systems configured to perform various network administration and monitoring functions in communication with the NEs 80a-80f. The NMS 99 may store detailed information about different elements and modules of the NEs 80a-80f and various resources thereof, including but not limited to nominal data rates at ports of the client-side (e.g., 81) and line-side (e.g., 83) interfaces and switching capacities of the NEs. The NMS 99 may also store information about the optical fiber links interconnecting the NEs 80a-80f, such as their length, optical loss, and characteristics of optical amplifiers that may be present in the optical fiber links and/or at the ends thereof. In some implementations, the NMS 99 may collect information from the NEs 80a-80f about utilization of various resources that may be provisioned at the NEs 80a-80f to support customer services on a per-service, or per-connection, basis.

In an example operation scenario, the terminal NE 80a may receive data traffic signals (“data streams”) 71 and 72 at client-side ports 81₁ and 81₂ for transmitting to the terminal NEs 80c and 80d, respectively. The optical network 85, e.g., the NMS 99 in communication with one or more of the NEs 80a-80f, may provision a first network connection along a network path, trail 61, for the data stream 71 between the NEs 80a and 80c, and another network connection along a network path, trail 62, for the data stream 72 between the NEs 80a and 80d. This may include provisioning client-side interface resources at the respective terminal NEs 80a, 80c, and 80d, and provisioning of switching resources at the switching NE 80f. In the illustrated example, the data streams 71 and 72 share the first leg of their respective trails and may be transmitted by the terminal NE 80a as tributaries of a HO digital container 75 of a sufficient capacity, e.g., an ODUk or OTUk. The terminal NE 80a may aggregate the data streams 71 and 72 into the HO container 75 and transmit an output data stream 77 comprising a sequence of those containers in an optical channel via a line-side port 83₂ toward the switching NE 80f. The switching NE 80f may convert optical signals received from the NE 80a into the electrical domain, de-multiplex the data streams 71 and 72, re-package them separately into different digital containers 95 and 97 of suitable nominal capacities, and transmit output data streams 91, 93 comprising those containers, 95 and 97, respectively, toward terminal NEs 80c and 80d, respectively. Optionally, the switching NE 80f can multiplex data streams 71 and 72 with other data streams 79 and 78, respectively, for co-propagating along the next segments of their respective trails. The digital containers 95 and 97 may be transmitted optically over the same wavelength or different wavelengths to respective ones of the terminal NEs 80c and 80d.

In an example implementation, the optical network 85 uses OTN digital wrapping to transmit data traffic signals across optical fiber links. The line capacities, i.e. internal data rates, of the OTN-compliant containers 75, 95, and 97 (“OTN containers”) are defined on a fixed grid, e.g., with approximately 1.25 Gbps or 2.5 Gbps granularity, and are typically chosen to be sufficiently large to accommodate peak data rates for all tributary signals, e.g., the data streams 71 and 72 in the example being described. Similarly, the client-side ports 81₁ and 81₂ that are assigned to data streams 71 and 72 may also be configured to support signals up to a specific data rate (“nominal port rate”), e.g. 1 Gbps, 10 Gbps, etc., which is typically greater than the actual data rate of the data streams 71 and 72. Thus, the resources of the terminal NE 80a assigned to services carried by the data streams 71 and 72, and similarly the resources of other NEs along the trails 61, 62 provisioned for the data streams 71 and 72 in the network 85, i.e. the NEs 80f, 80c, and 80d in the described example, are likely to be under-utilized.

In a conventional OTN-based network, a control and management system of the network may compile information on port and trail nominal resource provisioning but typically lacks the capability of tracking actual utilization of the network resources by the data traffic signals along the provisioned trails. For example, client services using a 100 GbE client interface would be assumed to use the full client interface capacity and the full nominal capacity of an OTN container assigned to the service, e.g. full ODU4. Typically, the client service may not be using the full interface and line capacity, but only a fraction of it. By way of example, for the client services using the 100 GbE interface example, an average peak data rate could be 40 Gbps, and mean data rate could be only 20 Gbps.

The optical network 85 may be configured to implement a system, and a corresponding method, of the present disclosure for tracking utilization of network resources in connection-switched optical networks, such as OTN-based networks, including tracking the utilization of client-network interfaces and provisioned line capacity. In various example implementations described below, the method of the present disclosure may allow capturing and transmitting per-service resource utilization information in a modular, scalable, aggregable fashion from a source interface to a destination interface. In some implementations, resource utilization information, e.g., in the form of a descriptor that comprises a utilization metric (UM), may be transmitted in-band from lower-order (LO) tributaries to corresponding higher-order (HO) digital containers, or vice versa, at multiplexing and demultiplexing points of the network. In some implementations, per-service resource utilization at network switches may be tracked using in-band transmission of per-tributary resource utilization information. This may include, e.g., inserting a resource utilization descriptor (RUD) into an overhead (OH) of a corresponding digital container, e.g., an OTN digital container.

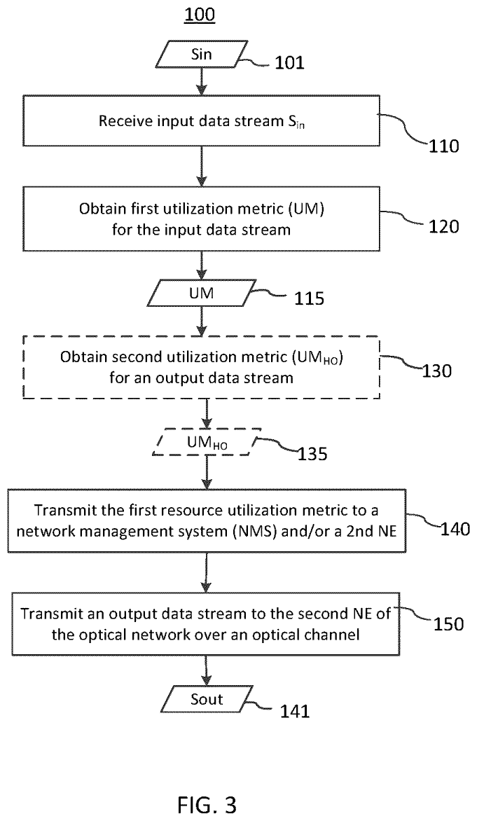

FIG. 3 shows a flowchart of a method 100 that a NE of a circuit-switched optical network, e.g. the terminal NE 80a of the optical network 85, may implement to facilitate the tracking of network resource utilization by a data stream associated with a client service. In the illustrated embodiment, method 100 includes step 110 of receiving, by a first NE of the optical network (e.g., 80a), an input data stream 101 Sᵢₙ, and step 120 of obtaining a first utilization metric 115 for the input data stream 101, the first utilization metric (UM) 115 being a measure of utilization of a resource by the input data stream 101. The input data stream 101 may be, e.g., one of the data streams 71 or 72 in FIG. 2. In some implementations, step 120 of method 100 may include performing resource utilization measurements at the first NE. Method 100 further includes step 140 of transmitting the first utilization metric 115 to an NMS (e.g., NMS 99 in FIG. 2) of the optical network and/or to a second NE (e.g., NE 80f in FIG. 2) of the optical network, and step 150 of transmitting an output data stream 141 to the second NE of the optical network over an optical channel, the output data stream 141 comprising at least the input data stream 101. In the example described above with reference to the optical network 85 and FIG. 2, the output data stream 141 may be, e.g., a data stream comprising a stream of digital containers 75.

In some implementations, steps 140 and 150 may be combined, and the first utilization metric 115 may be transmitted to the second NE (e.g., NE 80f in FIG. 2) “in-line” comprised in the output data stream 141, e.g., within a container encapsulating the input data stream 101. In some implementations, method 100 may further include step 130 of generating a second utilization metric “UM_{HO}” 135 for the output signal 141. Method 100 may further include transmitting the second utilization metric 135 to the NMS, and/or “in-line” to the second NE comprised in the output signal 141. In some implementations, the first NE may receive a plurality of the input data streams 101, and step 120 may include obtaining a first utilization metric 115 for each, or at least some, of the input data streams 101, e.g., by measurements.

Referring to FIG. 2, in an example embodiment, the terminal NE 80a of the optical network 85 may be configured to measure signal bit rates at each, or at least some, of the client-side ports 81₁, 81₂, 81₃ of the client-side interface 81 and to implement method 100 using those measurements. In the operation scenario described above with reference to FIG. 2, the NE 80a may first measure the bit rate of the data streams 71 and 72 received at client-side ports 81₁ and 81₂, respectively (e.g., at step 120 of method 100), and generate corresponding utilization metrics 115 based on the bit rate measurements and data rate capacity of said ports. In an example implementation, the first utilization metrics 115 for the client-side ports 81ₙ, denoted UMₙ, n=1, 2, may be assigned a value equal to a ratio of a data rate metric Rₙ (“used capacity”) and a nominal port data rate (“nominal capacity”) R_{cap,n}:

$${UM}_{n} = \frac{{R}_{n}}{{R}_{cap , n}} \qquad ( 1 )$$

The data rate metric Rₙ at a client-side port 81ₙ (n=1, 2, or 3) may be estimated in a variety of ways, e.g., based on an average data rate, a peak data rate, or a mean peak data rate (MPDR) measured at the corresponding port. A MPDR may be obtained, e.g., by averaging peak data rate values recorded for a plurality of time intervals, each peak data rate being a maximum data rate measured at a given port during one of the time intervals. By way of example, the NE 80a may measure signal data rate rᵢ at one of the two client-side ports 81₁ and 81₂ at a sampling rate Rₛₐₘₚₗₑ, detect a maximum (“peak”) data rate rₚₑₐₖ among the signal data rates rᵢ measured during a time interval T>2/Rₛₐₘₚₗₑ, and estimate the MPDR value Rₘₚ by averaging the peak data rate values rₚₑₐₖ detected for a sequence of such time intervals. The first utilization metrics UM 115 at the client-side ports 81₁ and 81₂ (n equal to 1 and 2, respectively) may then be estimated in accordance with equation (1) using Rₙ=Rₘₚ.

In some embodiments, a second utilization metric 135 may be generated as a measure of utilization of a data rate capacity of the HO containers 75 by the tributary signals thereof. The second utilization metric 135, UM_{HO}, may be computed based on the first utilization metrics 115 for the data streams 71 and 72 and a nominal data rate capacity R_{HO} of the HO container 75 carrying segments of the data streams 71 and 72 as payload tributaries, e.g. in accordance with equation (2):

$${UM}_{H O} = {\sum }_{n = 1}^{N} \frac{{R}_{tr , n} \cdot {UM}_{n}}{{R}_{HO}} , \qquad ( 2 )$$

where R_{tr,n}, n=1, . . . , N, are data rates of the payload tributaries in the HO container 75, and N is the number of the payload tributaries in the HO container 75; in the example of FIG. 2, N=2, with the R_{tr,1} R_{tr,2} being tributary data rates of the data streams 71 and 72 in the HO container 75. The utilization metrics given by equations (1) and (2) may also be referred to as line utilization metrics. At step 140, the second utilization metric 135, UM_{HO}, may be assigned to the output data stream 77 or the HO container 75.

In some implementations, the first utilization metrics 115 UMₙ and the second utilization metric 135 UM_{HO} may be generated at the terminal NE 80a using measurement and data processing capabilities local to the NE 80a. In some implementations, the results of the port data rate measurements may be communicated to the NMS 99, and steps 130, 140 and, possibly, 120 may be performed at least in part by the NMS 99. Steps 120 and/or 140 may include establishing a physical or logical link between the utilization metric and a corresponding signal or data stream. Establishing a physical link may include, e.g., adding the utilization metric to an overhead of a digital container carrying the signal, as described below. A logical link may be, e.g. logically linking the utilization metric and an ID of the corresponding data stream into a database accessible by the management system of the network.

In some implementations or network use scenarios, at least one of the data streams 71, 72 may comprise a corresponding first utilization metric 115 for said data stream, e.g., in an overhead of a corresponding digital container or frame. In some implementation, e.g. wherein the NE 80a lacks port rate measurements capability at one or more of the client-side ports 81₁ and 81₂, the first utilization metric 115 for the corresponding port or ports may be assigned at step 120 based on a pre-defined policy, e.g. by assigning to the first resource utilization metric 115 a pre-defined value, e.g. “1.0”, corresponding to the full utilization of the port data rate capacity. In some implementations, the first and second utilization metrics 115, 135 may be communicated by the NE 80a to the NMS 99. In some implementations, the NMS 99 may collect similar utilization metrics for the data streams 71 and 72 from other NEs along the end-to-end connections, trails 61 and 62, in the optical network 85 to track end-to-end utilization of the network resources by client services carried by each of the data streams 71 and 72. The NMS 99 may then use the utilization metrics collected for each of the end-to-end connections, trails 61 and 62, for network use pricing purposes.

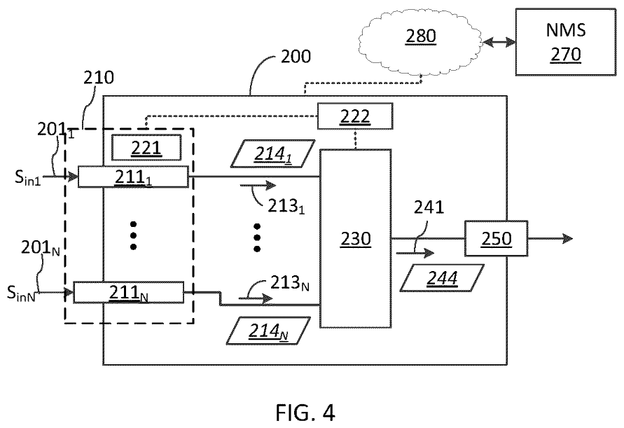

FIG. 4 is a schematic block diagram of an example user network interface (UNI) apparatus 200 (“UNI 200”). The UNI 200 may exemplify, or be a part of, any of the NEs 80a to 80e of the optical network 85 of FIG. 2 in some embodiments thereof. In the illustrated example, the UNI 200 includes a client-side interface 210 having N≥1 ports 211₁, . . . , 211_{N} (“ports 211ₙ”), a line-side interface 250, and a framer 230. The UNI 200 may be communicatively connected to an NMS 270 via a DCN 280. The NMS 270 may be an example of the NMS 99 described above. The ports 211₁, . . . , 211_{N} of the client-side interface 210 are configured to receive input data streams 201₁, . . . 201_{N} (“data streams 211ₙ”), denoted Sᵢₙ₁, . . . , S_{inN}, respectively, and convert them into corresponding digital port outputs 213₁, . . . , 213_{N}. The input data streams 201₁, . . . , 201_{N} may carry various client-supported services, such as video and/or audio streaming, messaging, VOIP, etc., and may include, e.g., Ethernet signals and, in some implementations, optical data signals, e.g., SDH/SONET, fiber channel (FC), or ONT compliant optical data signals that may be provided by a client optical interface card (not shown). The client-side interface 210 is further configured to pass the digital port outputs 213₁, . . . , 213_{N} to the framer 230, possibly after performing some initial signal processing, e.g. digital wrapping of the input data streams 201₁, . . . , 201_{N} into respective LO digital containers 214₁, . . . , 214_{N}, such as LO ODU, ODUflex, ODUC, etc. The framer 230 is configured to multiplex the digital port outputs 213₁, . . . , 213_{N} of the client-side ports 211ₙ (n=1, . . . , N) and package the multiplexed outputs as tributaries in HO digital containers 244, such as HO ODU, ODUflex, ODUC, etc., to be transmitted in an output data stream 241 over the line-side interface 250. The framer 230 may be embodied with one or more digital hardware processors, such as but not limited to one or more ASICs and/or FPGAs, typically including hardware logic. The line-side interface 250 may include an electrical-to-optical (EO) WDM converter (not shown) that is configured to transmit the output data stream 241 over an optical channel.

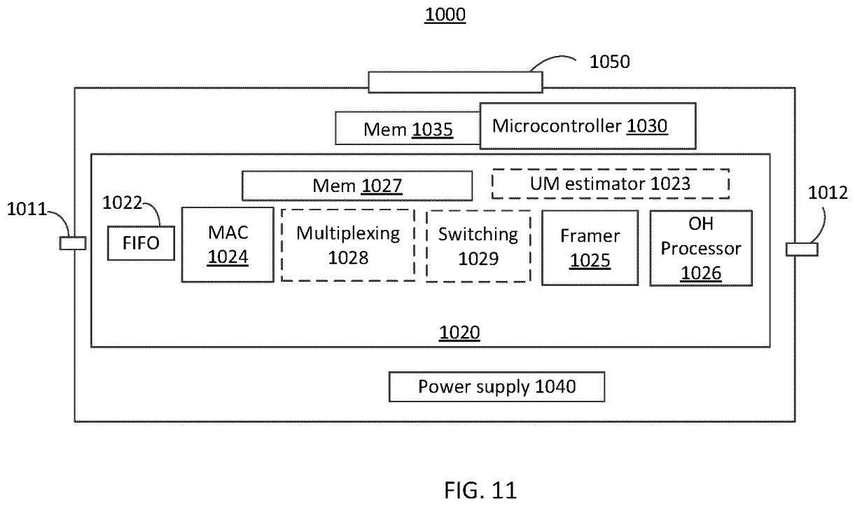

The UNI 200 may further include one or more resource utilization estimators (RUE), e.g., a first RUE 221 and a second RUE 222 in the illustrated example. The first RUE 221, which may also be referred to as the terminal RUE 221, may be communicatively coupled to the client-side interface 210 to collect interface resource utilization information, and may share data processing resources thereof. The second RUE 222, which may also be referred to as the multiplexer RUE 222, may be communicatively coupled to the framer 230 to collect information related to utilization of resources related to the multiplexing. The second RUE 222 may share resources of the framer 230. In some embodiments, the first and/or second RUE 221 and/or 222 may communicate the resource utilization information, e.g., different utilization metrics described above and below, to the NMS 270. In some embodiments, the second RUE 222 may be absent; in some of such embodiments, the function of estimating and/or tracking the utilization of resources related to the framer 230 may be implemented at least in part within the NMS 270. In some embodiments, the RUEs 221, 222 may be implemented using hardware logic (e.g., 1020, FIG. 11) and/or one or more microprocessors (e.g., 1030, FIG. 11) coupled to a memory device (e.g., 1035, FIG. 11) storing instructions executable by the one or more microprocessors. In some embodiments, the RUEs 221, 222 may use digital logic of the framer 230 and/or of framers internal to the client-side ports 211ₙ, e.g., parts of said logic (e.g., 1023 or 1026, FIG. 11) configured for processing container or frame overheads.

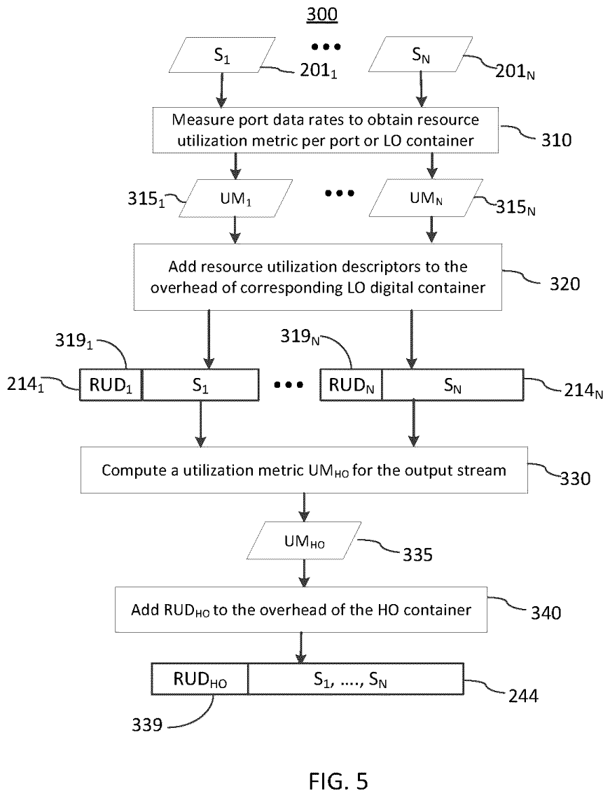

FIG. 5 shows a flowchart of method 300 for tracking line (i.e., data rate) resource utilization by customer data traffic at the UNI 200 according to an embodiment. Method 300 may be an example implementation of method 100 described above. In this example, the UNI 200, e.g. the client-side interface 210, may be equipped to periodically measure the data rate of each of the input data streams (tributary signals) 201₁, . . . , 201_{N} received at the client-side ports 211₁, . . . , 211_{N}, and may pass these measurements, possibly after some averaging, to the first RUE 221. In some implementations, the first RUE 221 may retrieve relevant port utilization information from the client-side interface 210, e.g., using a built-in bitrate measurements capability of the ports or indirectly by tracking relevant registers available in the client-side interface 210. By way of example, the client-side interface 210 may be an Ethernet interface which allows counting idle and/or data words over time, which may be used to estimate the data rate utilization metric of the interface. In some embodiments, the client-side interface 210 may be further configured to perform digital wrapping of the input data streams 201₁, . . . , 201_{N} such that each of the digital port outputs 213₁, . . . , 213_{N} is a sequence of corresponding LO digital containers 214₁, . . . , 214_{N}. Each such LO digital container 214ₙ, n=1, . . . , N, has a nominal data rate capacity, which may scale with the nominal data rate of the corresponding client-side port 211_{n.}

In accordance with method 300, at step 310 the UNI 200 may measure the data rate of each input data stream (tributary signal) 201₁, . . . , 201_{N} received at corresponding ports 211ₙ, and use the measurements to estimate line tributary utilization metrics UM₁ 315₁, . . . , UM_{N} 315_{N} (“UMₙ 315ₙ”) for corresponding input data streams 201ₙ, n=1, . . . , N, e.g. as described above with reference to method 100 and equation (1). These tributary utilization metrics 315ₙ may be added at step 320 to the overheads of the LO digital containers 214, having segments of corresponding input data streams 201, as the payload. In some implementations, the tributary utilization metrics 315ₙ may be added to the overheads of the corresponding LO digital containers 214, as parts of resource utilization descriptors (RUDs) RUD₁ 319₁, . . . , RUD_{N} 319_{N} (“tributary RUDs 319ₙ”). In some embodiments, each of the tributary RUD 319ₙ may comprise a corresponding tributary utilization metric UMₙ 315ₙ, e.g., a quantized value thereof, and may further comprise one or more other parameters, e.g., parameters indicating whether the corresponding tributary UMₙ 315ₙ is obtained via measurements, assigned without measurements in accordance with a policy, or extracted from the received data traffic signal.

In some implementations, the tributary RUDs 319ₙ, or the corresponding tributary UMₙ 315ₙ estimated by the first RUE 221, may be communicated to the NMS 270, either in addition to inserting the tributary RUDs 319ₙ in the corresponding LO digital containers 214, OH, or without such insertion. The framer 230 may aggregate two or more of the LO containers 214ₙ using time-domain multiplexing (TDM) into the payload of the HO digital container 244. The HO digital container 244 has a nominal data rate capacity R_{HO} that is at least equal to a sum of nominal data rate capacities R_{LO,n} of the LO containers 214ₙ. At step 330, the UNI 200, e.g. the second RUE 222, may use the tributary UMₙ 315ₙ to estimate a utilization metric UM_{HO} 335 for the HO container 244, e.g., as a weighted average of the tributary utilization metrics UMₙ 315ₙ in accordance with equation (2). At step 340, the UM_{HO} 335 may be added, e.g., by the framer 230 to the overhead of the HO digital container 244 for transmitting over an optical channel to a remote NE (e.g., 80f, FIG. 2). In some implementations, the UM_{HO} 335 may be added to the overhead of the HO digital container 244 as a part of a resource utilization descriptor 339, denoted “RUD_{HO}”. In some implementations, the UNI 200 may send the RUD_{HO} 339 or the UM_{HO} 335 via the DCN 280 to the NMS 270, either in addition or as an alternative to the insertion in the overhead of the HO digital container 244.

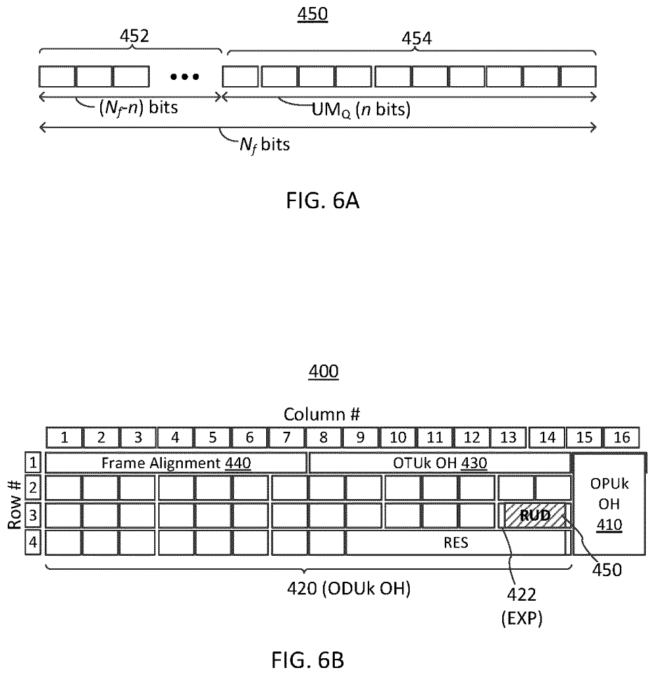

FIG. 6A illustrates an example structure of a RUD field 450 of a digital container overhead (OH). The RUD field 450 is a field of an OH where a resource utilization descriptor, such as RUDₙ 319ₙ or RUD_{HO} 339, may be inserted by a NE. In the illustrated example, the RUD field 450 is N_{f} bits long, and includes an n-bit UM field 454, n≥1, and a prefix field 452. The UM field 454 may contain a quantized UM value “UM_{Q}”. In an example implementation where the UM is in the range from 0 to 1, the quantized UM value UM_{Q} may be an n-bit digital word which binary value is closest (e.g. nearest integer) to the UM multiplied by (2ⁿ−1). A quantization error ΔR of this procedure, as a fraction of the total resource capacity Rᵣₑₛ, is about Rᵣₑₛ/2ⁿ. The prefix field 452 may contain, e.g., an “estimation type” (ET) bit or bits indicating whether the UM_{Q} value stored in the UM field 454 was obtained from measurements or estimated according to a policy. In some implementations, the prefix field 452 may contain a bit word representing an identifier (ID) of a NE where the UM_{Q} is estimated (“NEID”). In some implementations, the prefix field 452 may contain a bit word representing a resource identifier (“RID”), which identifies the resource (e.g., the line data rate in the examples described above) whose utilization the UM_{Q} estimates. In some implementations, the prefix field 452 may contain a bit word describing the type of estimation that was used to obtain the UM value (direct measurement, policy-defined, software-based, etc).

FIG. 6B schematically illustrates the structure of an OH 400 of an OTN transport container, e.g., OTUk. In the illustrated example, the container OH 400 includes an OPUk OH area 410, an ODUk OH area 420, an OTUk OH area 430, and a frame alignment area 440. The ODU OH area 420 includes an experimental (“EXP”) field 422, which is a two-byte field located in row 3, columns 13 and 14 of the ODU OH area 420. The EXP field 422, which is currently not subject to standards, may be used as the RUD field 450 where a RUD may be inserted in some embodiments of the present disclosure. In some implementations, reserved (RES) bytes of the container OH 400, which are currently undefined in the OTN standards and are set aside for future applications, may be used for the RUD field 450.

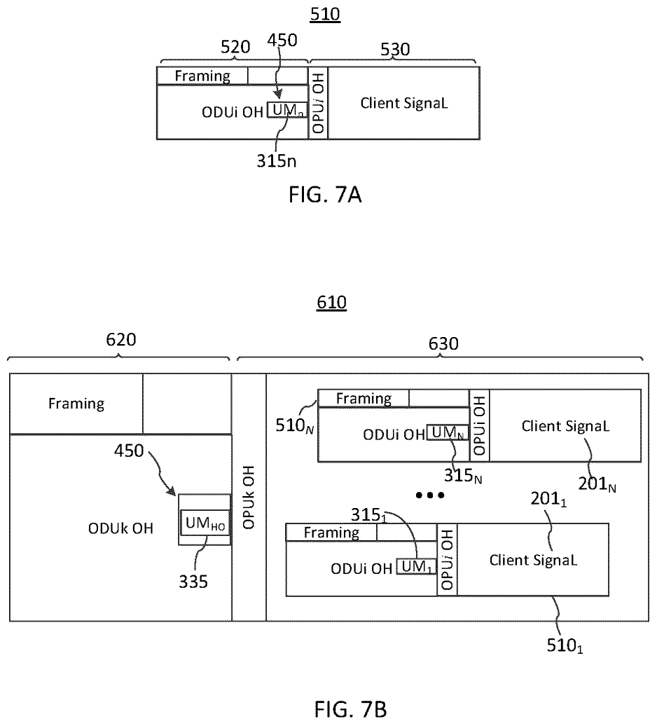

FIG. 7A shows a schematic structure of an ODUi 510, which may be an example of the LO digital containers 214ₙ. The ODUi 510 includes an ODUi OH 520 and an OPUi frame 530 as the ODUi payload. The OPUi frame 530 in turn includes a client signal, e.g., 201ₙ, as the payload. The ODUk OH 520 includes, e.g., a tributary UMₙ 315ₙ in a RUD field 450 thereof.

FIG. 7B shows a schematic structure of an ODUk 610, which may be an example of the HO digital container 244. The ODUk 610 includes an ODUk OH 620 and an OPUk frame 630 as the ODUk payload. The payload of the OPUk frame 630 includes an aggregation of N LO digital containers 510, i.e., ODUi 510₁, . . . , 510_{N}, which are combined using TDM. The ODUi 510₁, . . . , 510_{N} may include respective input data streams 201₁, . . . , 201_{N} in their respective payloads, and corresponding tributary UMₙ 315₁, . . . , 315_{N} in the RUD fields 450 of the respective ODUi overheads. The ODUk OH 620 may include the UM_{OH} 335 in a RUD field 450 thereof.

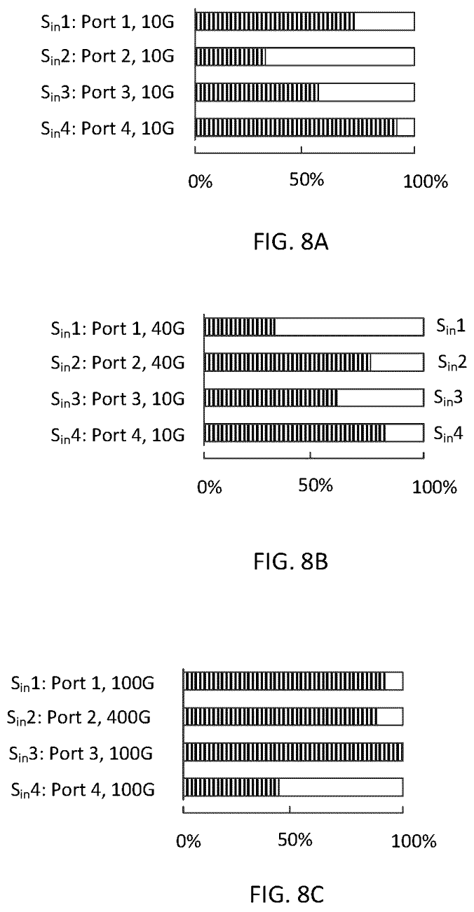

Examples of operation of the UNI 200 (FIG. 4) in accordance with method 300 (FIG. 5) are described below with reference to FIGS. 8A-8C. Referring first to FIG. 8A, in this example the client-side interface 210 may be a 4×10 GbE interface comprising four client-side ports 211ₙ, n=1, . . . , 4, which are indicated in FIG. 8A as “Port 1”, “Port 2”, “Port 3”, and “Port 4”, each configured to support a nominal data rate of 10 Gbps (“10G”). In an example scenario, these ports receive client signals “Sᵢₙ1”, “Sᵢₙ2”, “Sᵢₙ3”, and “Sᵢₙ4”, respectively, which correspond to the input data streams 201₁, . . . , 201_{N} in FIG. 4 for N=4. At step 310 of method 300, the UNI 200 performs data rate measurement at each of the four client-side ports “Port 1”, “Port 2”, “Port 3”, and “Port 4” and estimates, e.g., the mean peak data rates at the respective ports as 7.5 Gbps, 2.5 Gbps, 4.5 Gbps, and 9 Gbps, respectively. These rates correspond to port data rate utilization metrics UMₙ 315ₙ of 0.75, 0.25, 0.45, and 0.9, respectively (eq. 1). The UNI 200 may digitally wrap each of these signals into corresponding ODU2 (e.g., ODUi 510 with i=2, FIG. 7A) containers in accordance with the nominal port and ODU2 capacities, the four ODU2 containers embodying the LO digital containers 214₁, . . . , 214_{N} of FIG. 5. At step 320, the four estimated UMₙ values 315ₙ, or quantized versions thereof, may be added to the RUD fields 450 in the overheads of the corresponding ODU2 containers, so that the overheads of the ODU2 containers carrying the signals Sᵢₙ1, Sᵢₙ2, Sᵢₙ3, and Sᵢₙ4 include the UMₙ values 315ₙ equivalent to 0.75, 0.25, 0.45 and 0.9, respectively, and corresponding values may be inserted in the RUD fields 450 of the respective ODU2 containers 510. The framer 230 may then aggregate a quartet of ODU2 containers 510 carrying parallel segments of corresponding ones of the client signals “Sᵢₙ1”, “Sᵢₙ2”, “Sᵢₙ3”, and “Sᵢₙ4” as their payload, into an ODU4 container embodying the HO digital container 244 (e.g., ODUk 610 with k=4, FIG. 7B). At step 330, the second RUE 222 may compute the UM_{HO} 335 (FIG. 3) for the HO digital container 244, ODU4, based on the four UMₙ values. By way of example, the UM_{HO} 335 may be computed in accordance with equation (2), which in this example amounts to computing an average of the four tributary UMₙ values 315ₙ, UM_{OH}=(0.75+0.25+0.45+0.9)/4≅0.59. At step 340 this value, or a suitable representation thereof, e.g., quantized and in a binary format, may be added to the RUD field 450 of the ODU4 overhead.

Referring now to FIG. 8B, in this example the client-side interface 210 may include two 40 GbE (40G) ports and two 10 GbE (10G) ports. Input data streams “Sᵢₙ1” and “Sᵢₙ2” received at the two 40G ports are digitally wrapped into ODU3 containers ODU3-1 and ODU3-2, respectively, having nominal data rates of R_{ODU3}≅40.32 Gbps. Input data streams “Sᵢₙ3” and “Sᵢₙ4” received at the two 10G ports are digitally wrapped into ODU2 containers ODU2-1 and ODU2-2, respectively, having nominal data rates R_{ODU2}≅10.04 Gbps. The UNI 200 is configured to aggregate the four digitally wrapped input data streams into ODU4 containers having a rate capacity R_{ODU4}≅104.8 Gbps, embodying the output HO digital container 244. In an example scenario, the average peak rates estimated by the UNI 200 at the two 40G ports are, respectively, a quarter and three quarters of the nominal ODU3 data rate, corresponding to the ODU3 container utilization metrics UM₁=0.25 for ODU3-1 and UM₂=0.75 for ODU3-2; these values may be inserted in the RUD fields 450 of their respective overheads. The average peak rates estimated at step 310 by the UNI 200 at the two 10G ports are, respectively, 60% and 80% of the nominal ODU2 data rate, corresponding to the ODU2 container utilization metrics UM₃=0.6 for ODU2-1 and UM₄=0.8 for ODU2-1; these values may be inserted in the RUD fields 450 of the ODU2-1 OH and the ODU2-2 OH, respectively. At step 330, the UNI 200 may compute the utilization metric UM_{HO} 335 of the HO digital container ODU4, UM_{HO}, based on the UMₙ, n=1, . . . , 4 values for the tributary ODU3 and ODU2 containers as

$${UM}_{HO} = [ {R}_{ODU 3} \cdot ( {UM}_{1} + {UM}_{2} ) + {R}_{ODU 2} \cdot ( {UM}_{3} + {UM}_{4} ) ] / {R}_{ODU 4} ≅ 0.52 .$$

The UNI 200 may then insert the estimated UM_{HO} value of 0.52, e.g., as a part of the RUD_{HO} 339, in the RUD field 450 of the ODU4 container (HO digital container 244) aggregating the containers ODU3-1, ODU3-2, ODU2-1 and ODU2-2.

FIG. 8C illustrates another example, wherein the client-side interface 210 includes three 100G (e.g., 100 GbE) ports and one 400G (e.g., 400 GbE) port. The framer 230 in this example is configured to aggregate outputs of these four ports into HO digital containers ODUC7 having a nominal data rate of approximately 700 Gbps (“700G”). Actual data rates of the corresponding client signals “Sᵢₙ1”, “Sᵢₙ2”, “Sᵢₙ3” and “Sᵢₙ4” are smaller than the nominal capacity of the corresponding ports. In the example of FIG. 8C, the three 100G ports are determined to have line UM values UM₁≅0.9 (Port 1), UM₃≅1.0 (Port 3), and UM₄≅0.45 (Port 4). This may correspond to the UNI 200 measuring mean peak data rates at said ports of approximately 90 Gbps, 100 Gbps, and 45 Gbps, respectively. The 400G port is determined to have a line MU value of approximately 0.85; this may correspond to a mean peak data rate at Port 3 of approximately 340 Gbps. A TDM of the four signals “Sᵢₙ1”, “Sᵢₙ2”, “Sᵢₙ3” and “Sᵢₙ4” in this example has a data rate of approximately 575 Gbps, which is about 82% of the nominal data rate of an ODUC7 container. In accordance with step 340 of method 300, the UNI 200 may insert a UM_{HO} value of 0.82 in the RUD field 450 of the OH of the ODUC7 container carrying the four signals “Sᵢₙ1”, “Sᵢₙ2”, “Sᵢₙ3” and “Sᵢₙ4” in the payload.

In the example of FIG. 8C, the input signals “Sᵢₙ1”, “Sᵢₙ3” and “Sᵢₙ4” received at the 100G ports may each be digitally wrapped, e.g. by the UNI 200 or at signal source(s), into ODU4 containers. The input signal “Sᵢₙ2” received at the 400G port may be digitally wrapped, e.g. by the UNI 200 or at a source of the signal, into ODUC4 containers. In some scenarios, the UNI 200 may digitally wrap the four input signals in respective ODU4 or ODUC4 containers and insert corresponding RUDs in the overheads thereof. In some scenarios, the UNI 200 may receive one or more of these four input signals digitally wrapped in respective ODU4 or ODUC4 containers, and the UNI 200 may add corresponding RUDs in the headers thereof absent of an RUD. In some scenarios, the UNI 200 may receive one or more of these four input signals digitally wrapped in respective ODU4 or ODUC4 containers that include a corresponding RUD, and the UNI 200 may use the RUD received with the container to compute the RUD_{HO} for the HO digital container ODUC7.

Some embodiments may use a separate utilization metric in relation to a network resource, estimated as a ratio of provisioned capacity “Cₚᵣₒᵥ” to a total capacity “Cₜₒₜₐₗ” of the resource,

$${UM}_{prov} = {C}_{prov} / {C}_{total} , \qquad ( 3 )$$

which may be referred to here as the provisioned UM. For example, a network management entity may provision an ODU3 container having a payload bit rate of approximately 40 Gbps (Cₜₒₜₐₗ in eq. 3) to carry 3 ODU2 containers with payload bit rates of about 10 Gbps each (Cₚᵣₒᵥ=3·10 Gbps). The ODU3 container may then be assigned an UMₚᵣₒᵥ=3·10 Gbps/40 Gbps=0.75.

Referring again to FIGS. 4 and 5, the HO digital container(s) 244 may be transmitted over an optical channel to another NE, such as the switching NE 80f of FIG. 2. Different tributaries (i.e. different ones of the LO digital containers 214₁, . . . , 214_{N}) of the HO digital containers 244 may be destined to different terminal NEs of the optical transport network. A switching NE, e.g. 80f, may be configured to demultiplex incoming HO digital containers into its tributaries and re-multiplex a subset of one or more of the tributaries into new output HO digital containers for transmitting to the different downstream NEs.

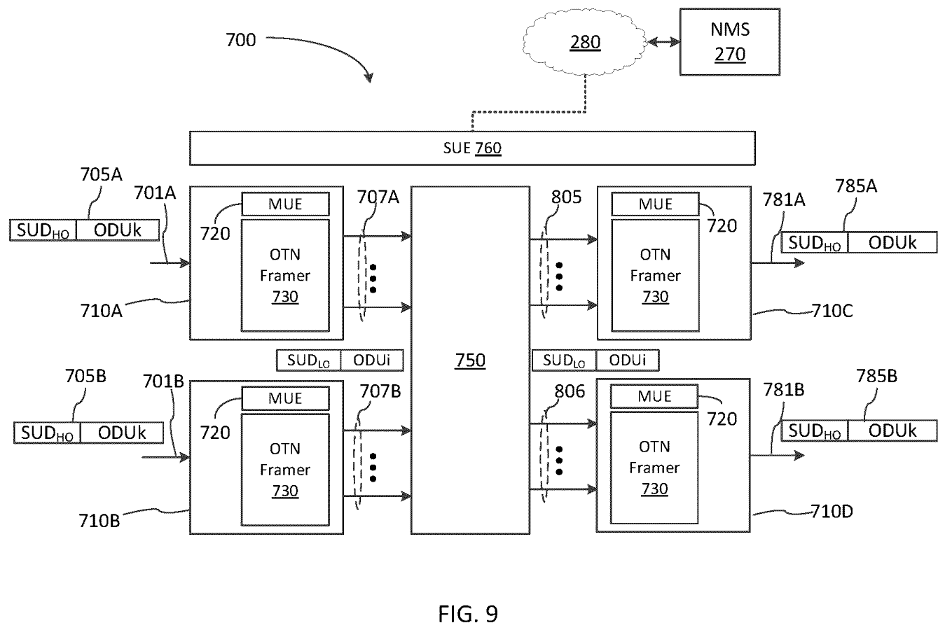

FIG. 9 shows a schematic block diagram of an example switching NE 700 (“SNE 700”), which may be an embodiment of the switching NE 80f of FIG. 2. The SNE 700 includes four network interface devices (“NIDs”), 710A, 710B, 710C, and 710C (“NIDs 710A-710C”) interconnected via a switch fabric 750, and may further include a switching utilization estimator (SUE) 760. Each of the NIDs 710A-710C includes a framer 730, e.g., an OTN framer, and may further include a multiplexing utilization estimator (MUE) 720. The NIDs 710A-710C may be configured to receive optical signals carrying data streams arranged into input HO digital containers, demultiplex the received input HO digital containers into one or more tributary containers and pass the demultiplexed tributary containers to the switch fabric 750. Each of the NIDs 710A-710C may further be configured to aggregate selected subsets of the tributary containers received from the switch fabric 750 into output HO digital containers. The switch fabric 750 may be configured to route received tributary containers to corresponding ones of the NIDs 710A-710C based on information in the tributary container overheads.

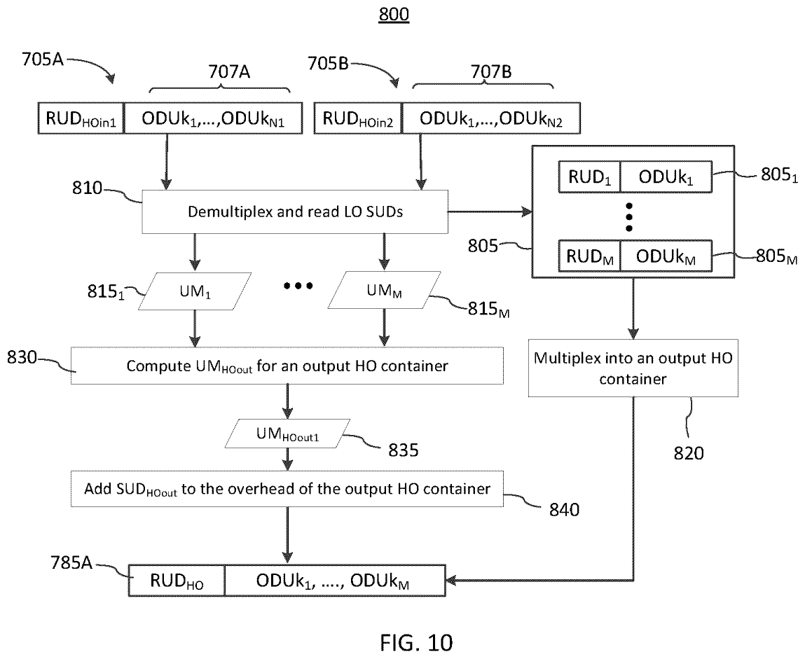

Arrows in FIG. 9 illustrate an example of the SNE 700 operation when the NIDs 710A and 710B receive input signals 701A and 701B, and the NIDs 710C and 710D transmit output signals 781A and 781B. The input signals 701A and 701B may be optical signals carrying input HO digital OTN containers 705A and 705B, respectively. The output signals 781A and 781B may be optical signals carrying output HO digital OTN containers 785A and 785B, respectively. The output HO digital OTN containers 785A and 785B may include subsets of tributaries, e.g., LO digital OTN containers, of the input HO digital OTN containers 705A and 705B in different combinations. The MUE 720 and the SUE 760 may be embodied with one or more digital processors, such as one or more microprocessors, and/or hardware logic of the framers 730 and/or the switch fabric 750. The SNE 700 may be configured to operate in accordance with method 800 for network resource utilization tracking that is illustrated in FIG. 10.

FIG. 10 is a flowchart of method 800 that a switching NE such as the SNE 700 may implement to track utilization of data rate (“line capacity”) resources at the SNE 700 to route received data traffic. Referring to the SNE 700 by way of example, the SNE 700 may operate to route a subset of M tributaries of at least one of the input HO digital containers 705A and 705B over an optical channel to a downstream NE (e.g., 80c, FIG. 2) in the payload of the output HO digital containers 785A. In accordance with method 800, at step 810 the NIDs 810A and 810B may demultiplex the input HO digital containers 705A and/or 705B into their respective tributary LO digital containers, such as the containers 510₁, . . . , 510_{N} of FIG. 7B. By way of example, the input HO digital container 705A may include, as tributaries, a first set 707A of N₁ tributary LO containers {ODUk₁, . . . , ODUK_{N1}}, and the input HO digital container 705B may include a second set 707B of N₂ tributary LO containers {ODUk₁, . . . , ODUK_{N2}}. Here, similarly named tributary LO containers from the first and second set, e.g. the LO containers named ODUₖ₁, may be OTN containers of different capacities. Step 810 may further include the switch fabric 750 operating to route a subset 805 of M tributary LO containers 805₁, . . . , 805_{M} to the NID 710C, the LO containers 805₁, . . . , 805_{M} of the subset 805 being selected from the first set 707A and/or the second set 707B of tributary LO tributary containers.

Step 810 may further include determining a set of M utilization metrics UM₁ 815₁, . . . , UM_{M} 815_{M} corresponding to the subset of M tributary LO containers 805₁, . . . , 805_{M} to be transmitted sharing the output HO digital containers 785A. In an example scenario, each of the subset of M tributary LO containers 805ₘ, m=1, . . . . M, may include a corresponding UMₘ 815ₘ in the overhead thereof, and may be read by the MUE 720 of a corresponding one of the NID 710A or 710B. In another example, the NID 710A and/or NID 710B may be configured to measure the data rates of the corresponding tributary signals and estimate one or more of the utilization metrics UMₘ 815ₘ for the corresponding tributary LO containers 805ₘ based on the measurements, as described above with reference to FIGS. 4-8C and method 300.

At step 820, the NID 710C may aggregate the subset of M tributary LO containers 805₁, . . . , 805_{M} into the output HO digital container 785A as a payload thereof. At step 830, the SUE 760 may compute a new utilization metric 835, denoted UM_{HOout}, based on the set of UMₙ 815₁, . . . , UMₙ 815ₙ values comprised in the subset of M tributary LO containers 805₁, . . . , 805_{M}, e.g. as described above with reference to equation (2) and FIGS. 5 and 8A-8C. At step 840, the new utilization metric 835, UM_{HOout}, may be inserted into an overhead of the output HO digital container 785A, e.g., in the RUD field 450 thereof.

By way of example, the NID 710A may receive a 40G data stream over the input optical signal 701A, the 40G data stream comprising a sequence of ODU3 containers as the input HO digital containers 705A. In parallel, the NID 710B may receive a 700G data stream over the input optical signal 701B, the 700G data stream comprising a sequence of OTN ODUC7 containers as the input HO digital containers 705B. Furthermore, in this example the SNE 700 may include an additional NID (not shown in FIG. 9) receiving a 400G signal “Sᵢₙ3,1” wrapped in 400G ODUC4 containers.

The ODU3 containers received at the NID 710A in this example carry four ODU2 containers {Sᵢₙ1,1 (10G,0.75)}, {Sᵢₙ1,2 (10G,0.25)}, {Sᵢₙ1,3 (10G,0.45)}, and {Sᵢₙ1,4 (10G,1.0)} as tributaries, which the NID 710A demultiplexes and passes to the switch fabric 750. Here and in the following the notation of the form {Sᵢₙi,j(a,b)} indicates a digital container having a nominal bit rate of a, carrying in the payload a signal Sᵢₙ received at j-th port of an i-th interface, and carrying a utilization metric “b” in the OH (i.e., the data rate of the payload signal is approximately UM·R. E.g., {Sᵢₙ1,1 (10G,0.75)} indicates a container having a container bit rate of approximately 10G and a tributary signal “Sᵢₙ1,1” in the payload and an UM of 0.75 in the OH, said signal Sᵢₙ1,1 having a data rate of approximately 10G·0.75=7.5G. The MUE 720 of the NID 710A may read the utilization metrics 0.75, 0.25, 0.45, and 1.0 indicated above, from the RUD fields 450 in the overheads of the corresponding tributary containers and pass those utilization metrics to the SUE 760.

Each of the 700G ODUC7 containers received at the NID 710B in this example carries four 100G ODUC4 tributary containers {Sᵢₙ2,1 (100G,0.9)}, {Sᵢₙ2,2 (100G,0.85)}, {Sᵢₙ2,3 (100G,1.0)}, and {Sᵢₙ2,4 (100G,0.45)} in respective payloads thereof; here again the pair of bracketed values are the nominal bit rates of the corresponding tributary LO containers and the utilization metrics of that nominal bit rate by the data signal carried in the container's payload. The NID 710A demultiplexes the four ODUC4 containers from the ODUC7 payload and passes them to the switch fabric 750. In some embodiments, the MUE 720 of the NID 710B may read the utilization metrics 0.9, 0.85, 1.0, and 0.45 indicated above from the overheads of the corresponding tributary containers demultiplexed by the NID 710B and may pass those utilization metrics to the SUE 760. Similarly, the additional NID receiving the signal comprising 400G ODUC4 containers {Sᵢₙ3,1 (400G,0.8)} may read a corresponding rate utilization metric, i.e., 0.8, from the RUD field 450 of the container overhead and pass this utilization metric to the SUE 760. In this example, the additional NID transmits the received 400G ODUC4 containers to the switch fabric 750 without demultiplexing.

Further by way of example, the switch fabric 750 may send to the NID 710C, as the subset 805 of tributary LO containers 805ₙ of FIG. 10, three of the demultiplexed containers {Sᵢₙ1,1 (10G;0.75)}, {Sᵢₙ1,2 (10G;0.25)}, {Sᵢₙ1,3 (10G;0.45)} received from the NID 710A plus the containers {Sᵢₙ2,4 (100G;0,45)} received from the additional NID, for aggregating into 200G ODUC2 (the output HO digital container 785A). The utilization metric UM_{HO} of the containers ODUC2 assembled at the NID 710C may be estimated, e.g., by the SUE 760 or the MUE 720 of the NID 710C, based on the set of utilization metrics UM₁ 815₁, . . . , UM_{M} 815_{M} of its LO tributaries and the tributary container rates, e.g., in accordance with equation (2). In this example, the utilization metric of the ODUC2 containers (e.g., the output HO digital container 785A, FIGS. 9, 10) assembled by the NID 710C, UM_{HOout1}=[10G·(0.75+0.45+0.25)+100G·0.45]/200G=0.3; this value may be added to the RUD field 450 of the ODUC2 OH, e.g., by the MUE 720 and/or the Framer 730 of the NID 710C.

In parallel, the switch fabric 750 may send to the NID 710D, a second subset 806 (FIG. 9) of the demultiplexed tributary LO containers received from the NID 710A and NID 710B, e.g., the containers {Sᵢₙ1,4 (10G,1)}, {Sᵢₙ2,1 (100G,0.9)}, {Sᵢₙ2,2 (100G,0.85)}, {Sᵢₙ2,3 (100G,1.0)}, and {Sᵢₙ3,1 (400G,0.8)}, for aggregating into 800G ODUC8 (the output HO digital container 785B). The utilization metric of the output HO digital container 785B, the ODUC8 in this example, may be similarly estimated based on the utilization metrics of its tributary LO containers as UR_{HOout1}=[10G·1+100G. (0.9+0.85+1.0)+400G·0.8]/800G=0.76; this value, or its quantized binary representation, may be added in the overheads of the ODUC8 containers (785B) by the MUE 720 and/or Framer 730 of the NID 710D.

Example embodiments described above relate to utilization of one resource type that a connection-switched optical transport network may provide to support end-to-end customer traffic, i.e., the data rate resource. Techniques described above may however be applicable to network-wide tracking, in a per-service or per-connection fashion, other utilization or cost metrics of other network resources that may be associated with a service, including but not limited to memory utilization, power utilization, and OTN switching fabric utilization.

Tracking memory utilization may include measuring an average or maximum amount of memory used by data signal(s) associated with a service at different nodes or NEs that the data signal(s) associated with the service traverse. In some implementations, digital processing equipment of NEs of the optical network may be equipped to query host card memory resources, such as but not limited to client interface MAC modules, FIFOs, microcontrollers, FPGA memory utilized for OH processing. E.g., FIFO memory buffers may be queried to determine a FIFO filling ratio, which may than be used as a memory utilization metric. In some implementations, a memory utilization metric may also be obtained based on memory pointers associated with memory spaces dedicated to serve a specific service or traffic flow. Once estimated, the memory utilization metric may be added to the overhead of the corresponding OTN container composed by the framer to be transmitted to a downstream NE, e.g., at a distinct location in the RUD field 450, and/or sent through a DCN (e.g. 280, FIG. 4) to a central management tool of the optical network (e.g., NMS 99, FIG. 2; NMS 270, FIGS. 4, 9).

In some embodiments, one or more hardware modules of a NE may be configured to provide estimates of power consumption by the corresponding hardware module. Examples of such hardware modules include, but are not limited to, modules implementing the line-side and client-side interfaces and/or traffic switching, which may include optical transceivers, transponders, muxponders, and/or digital traffic switching and/or routing hardware. As an example, in some embodiments the UNI 200 may include a card, e.g. a transponder or a muxponder, that is configured to periodically measure its power utilization, e.g. using the first and/or second RUE 221 and/or 222. In some embodiments, the first RUE 221 may be configured to assign each one of the input data streams 201ₙ a corresponding fraction of the measured power consumption in accordance with a pre-defined rule, e.g., in proportion to the nominal or actual data rate of the corresponding input data signal 201ₙ. By way of example, in operation an embodiment of the UNI 200 with two client-side ports 211₁ and 211_{N} (N=2) receiving a 100G input data stream (201₁, Sᵢₙ1) at client-side port 211₁ and a 400G input data stream (201_{N},S_{inN}) at client-side port 211_{N} may report 200 W of power consumption; the first and/or second RUE 221 and/or 222 may allocate 40 W to a service associated with the 100G input data stream (201₁, Sᵢₙ1) and 160 W to a service associated with the 400G input data stream (201_{N}, S_{inN}). Other methods of per-service power utilization may also be implemented, which may additionally account for, e.g., type of the interface or switching hardware. The per-service power utilization metrics, e.g., digital representations of 40 W and 160 W in this example, may be added to the overheads of the corresponding LO digital containers 214₁ and 214_{N} for transmitting to a next NE along the end-to-end service connection path in the optical network, or communicated to a central management tool of the optical network (e.g., NMS 270, FIG. 4 through a DCN (e.g. 280, FIG. 4).

OTN switching fabric utilization: in some implementations an optical network may include one or more OTN switches, such as e.g. embodied by the SNE 700 of FIG. 9, which is configured to allocate a switching resource to a traffic flow being tracked. By way of example, an embodiment of the SNE 700 having a total switching capacity of 10 Tbps is used to switch a service with a traffic flow of 0.4 Tbps; in this example, the SNE 700 may assign the service a relative switch utilization metric, e.g. 4% of the total switching capacity at the SNE 700, or a digital representation of the non-normalized switching resource being used by the service, e.g., measured in bit rate units. This switching resource usage information can be encapsulated in a RUD that may be transmitted in an OTN container overhead of the corresponding traffic flow and/or transmitted to the central management tool of the network.

In some implementations, non-normalized metrics of resource utilization by a service or traffic flow being tracked that are obtained at different NEs may be simply summed, so that the metric at the destination terminal is a measure of a total end-to-end resource cost used by the tracked service.

By way of example, a service associated with a data traffic signal, such as input data stream 201 (FIG. 4), may use 6 MB of memory resources of the UNI 200. The first RUE 221 may insert a digital representation of this value, “mUM₁”, into a RUD field of a header of the LO digital container 214₁. An optical signal carrying this container as a tributary may be received by the SNE 700, e.g. at the NID 710A, for transmitting along a provisioned network connection via the NID 710C. The SNE 700 may estimate using 10 MB of memory resources for de-multiplexing, switching, and re-multiplexing the LO digital container 214₁, add a digital representation of the 10 MB value, “mUM₂” to the value “mUM₁” read from the RUD field of the LO digital container 214₁ OH, and re-write a corresponding part of the RUD field of the LO digital container 214₁ OH with a summed value “mUM₁+mUM₁” corresponding to a total of 16 MB. This procedure may be repeated at each subsequent NE traversed by the input data stream 201, so that at the point of network egress the memory utilization metric in the LO digital container 214₁ OH provides information about the end-to-end memory resource used by the service.

By way of another example, the service associated with a data traffic signal, such as input data stream 201 (FIG. 4), may use 60 W of power at the UNI 200. The first RUE 221 may insert a digital representation of this value, “pUM₁”, into a corresponding RUD field of the LO digital container 214₁ OH. An optical signal carrying this container as a tributary may be received by the SNE 700 via the NID 710A for transmitting along the provisioned network connection via the NID 710C. The SNE 700 may estimate using 80 W of electrical power for de-multiplexing, switching, and re-multiplexing the LO digital container 214₁, add a digital representation of the 80 W value, “pUM₂” to the value “pUM₁” read from the RUD field of the LO digital container 214₁ OH, and re-write a corresponding part of the RUD field of the LO digital container 214₁ OH with a summed value “pUM₁+pUM₁” corresponding to a total of 140 W of used power. This procedure may be repeated at each subsequent NE traversed by the input data stream 201, so that the power utilization metric in the LO digital container 214₁ OH at the point of network egress provides information about the end-to-end power consumption by the service.

FIG. 11 is a block diagram of an example network device 1000 that may be used with the systems and methods described herein. The example network device 1000 may be used in embodiments of any one of the NEs 80a-80f, the UNI 200, and the SNE 700. The example network device 1000 may be a part of an optical transponder card, an optical muxponder card, a switch (e.g., an OTN switch), a cross-connect, a router, an access/aggregation device, etc. That is, the network device 1000 may be any digital system with ingress and egress digital signals, signal aggregation, and/or switching of channels, timeslots, tributary units, etc. In an example embodiment, the network device 1000 includes one or more first signal ports 1011, one or more second signal ports 1012, hardware logic 1020, microcontroller 1030, memory 1035 coupled to the microcontroller 1030, and power supply circuitry 1040. Memory 1035 may be a separate hardware device or integrated with the microcontroller 1030. The one or more first signal ports 1011 may be, e.g., client-side interface ports, and the one or more second ports 1012 may be, e.g., line-side interface ports. The signal ports 1011 and 1012 may be signal transmission media, e.g., segments of an RF transmission line. In some embodiments, the network device 1000 may include one or more control interfaces 1050 to connect to a host device and/or to a remote NMS via a DCN (e.g. 280).

The microcontroller 1030 may be a microprocessor configured to execute software instructions saved in a memory 1035, such as instructions to handle configuration, monitoring, and management of the network device 1000. Memory 1035 may also store management software that provides a user-friendly graphical interface for network operators to configure, monitor, and manage the hardware and services supported by the network device 1000. In some embodiments, memory 1035 may include instructions to perform or coordinate resource utilization measurements and computing and/or assignments of utilization metrics as described above, including some or part of the functionalities described above with reference to one or more of the utilization estimators first RUE 221, second RUE 222, MUE 720, and/or SUE 760.

The hardware logic 1020 may include, e.g., an ASIC, an FPGA, or a combination thereof. The hardware logic 1020 may be configured to include at least some of the following modules: one or more first-in first-out (FIFO) memory buffers 1022, a MAC (media access control) module 1024, an OTN framer 1025, an OH processor 1026, and memory 1027. The MAC module 1024 handles the data link layer functions, such as framing, error checking, and controlling access to the physical transmission medium of ports 1011. The MAC module 1024 may include PCS (Physical Coding Sublayer) and PMA (Physical Medium Attachment) modules, which are responsible for encoding and decoding data, distributing data across multiple lanes, serialization and deserialization of data, clock and data recovery, and data streams synchronization and aligned for multiplexing and demultiplexing. In some embodiments, the hardware logic 1020 may include signal switching or routing logic 1029 and/or signal multiplexing logic 1028. Memory 1027 may include memory for OH processing, memory used for digital signal processing (DSP) at the line interface, memory used for FIFO queues in Ethernet MAC for each client interface, etc. In some embodiments, the hardware logic 1020 may be configured to perform, by itself or in cooperation with the microcontroller 1030, some or part of the resource utilization tracking functionalities described above with reference to one or more of the utilization estimators first RUE 221, second RUE 222, MUE 720, and/or SUE 760. In some embodiments, the hardware logic 1020 may include a utilization estimation logic 1023 configured to perform at least some of the resource utilization measurement functions described above.

The above described techniques for tracking resource utilization along established connections may enable a centralized network management tool, e.g. the NMS 99 or 270, to estimate an actual amount of network resources (client ports, line capacity, switching capacity, CPU/GPU processing time, etc) that is attributable to a service or set of services, and use this information for adjusting service pricing policies, network upgrade planning, and routing algorithm optimization. Using an end-to-end resource utilization feature as described above, a network operator can assess the overall cost of serving a specific connection request as well as the prospect of already-established services that will be competing for the same resources as the requested one. For example, by observing the measured interface utilization, the network operator may be able to inform the end user that the interface is reaching the capacity limit and propose additional resources and may have a clear understanding of the cost of this additional capacity. Network resources associated with a service whose utilization may be tracked using techniques described above include those hardware and network elements, components or sub-components of the network that are used (in a dedicated or shared manner) to support data traffic associated with the service, and that provide various network functions, such as but not limited to encapsulation, framing, routing, encryption, optoelectronic conversion, digital-to-analog conversion, OH processing, multiplexing, inverse multiplexing, de-skewing, and the like.

The example embodiments described above are not intended to be limiting, and many variations will become apparent to a skilled reader having the benefit of the present disclosure. For example, resource utilization variables other that the ones described above may be tracked in some embodiments using devices, systems, and methods described above, such as, e.g., the length of optical fiber used by a service at each NE and end-to-end, a product of optical bandwidth provisioned to a service at a network element (e.g., optical channel spacing), a length of the optical fiber propagation distance used by the service (i.e. [GHz×km] product), and the number of pluggable modules used by the service at each NE and end-to-end.

According to an example embodiment disclosed above, e.g., in the summary section and/or in reference to any one or any combination of some or all of FIGS. 1-11, provided is a method (e.g., 100, FIG. 3; 300, FIG. 5; 800, FIG. 10) for an optical network (e.g., 85, FIG. 2). The method comprises: receiving, by a first network element (NE) (e.g., 80a, FIG. 2; 200, FIG. 4; 700, FIG. 9) of the optical network, at least one input data stream (e.g., 71 and/or 72, FIG. 2; 101, FIG. 3; 201₁, . . . , 201_{N}, FIG. 4); obtaining, by the first NE, at least one first utilization metric (e.g., 115, FIG. 3; 315₁, . . . , 315ₙ, FIG. 5) for utilization of a resource by the at least one input data stream; transmitting an output data stream (e.g., 77, FIG. 2; 141, FIG. 3; 241, FIG. 4) to a second NE of the optical network (e.g., 80f, FIG. 2) over an optical channel, the output data stream comprising the at least one input data stream; and transmitting the at least one first utilization metric to at least one of a network management system (NMS) (e.g., 99, FIG. 2; 270, FIGS. 4, 9) of the optical network or the second NE.

Some implementations of the method may comprise transmitting the at least one first utilization metric in an overhead (e.g., 400, FIG. 6B; 520, FIG. 7A) of at least one first digital container (e.g., 214₁, . . . , 214_{N}, FIGS. 4, 5; 510, FIG. 7A) encapsulating the at least one input data stream. Some implementations of the method may comprise transmitting the at least one first utilization metric to the NMS over a digital communications network (e.g., 280, FIGS. 4,9).

Any of the above implementations may comprise computing a second utilization metric (e.g., 135, FIG. 3; 335, FIG. 5; 835, FIG. 10) for the output data stream based at least in part on the at least one first utilization metric, and transmitting the second utilization metric to at least one of the NMS of the optical network or the second NE (e.g., 80f, 80c, or 80d, FIG. 2). Any such implementation may comprise transmitting the second utilization metric in an overhead (e.g., 620, FIG. 7B) of a higher-order (HO) digital container (e.g., 244, FIGS. 4, 5; 610, FIG. 7B; 785A, FIGS. 9, 10) encapsulating the at least one first digital container.

In any of the above implementations, the at least one input data stream may comprise a plurality of input data streams (e.g., 71 and 72, FIG. 2; 201₁, . . . , 201_{N}, FIG. 4), the output data stream may comprise an aggregation of the plurality of input data streams, and the method may comprise obtaining a plurality of first utilization metrics (e.g., 315₁, . . . , 315ₙ, FIG. 5) for the plurality of input data streams. Some implementations may comprise transmitting the plurality of first utilization metrics in overheads (e.g., 400, FIG. 6B; 520, FIG. 7A) of first digital containers (e.g., 510, FIG. 7A; 510₁, . . . , 510_{N}, FIG. 7B) encapsulating corresponding ones of the plurality of input data streams (e.g., 201₁, . . . , 201_{N}, FIG. 7B). Some implementations may comprise computing the second utilization metric based on the plurality of first utilization metrics. Some implementations may further comprise transmitting the second utilization metric in an overhead of a higher-order (HO) digital container (e.g., 244, FIGS. 4, 5; 610, FIG. 7B) encapsulating the first digital containers.

Any implementation of the method comprising transmitting the plurality of first utilization metrics in overheads of first digital containers may further comprise: encapsulating, at the second NE (e.g., 80f, FIG. 2), a subset (e.g., 805, FIG. 10) of the first digital containers (e.g., 805₁, . . . , 805_{M}, FIG. 10) received over the optical channel from the first NE, for transmitting to a third NE (e.g., 80c or 80d, FIG. 2) of the optical network (e.g., 85, FIG. 2) in a higher-order (HO) digital container (e.g., 785A or 785B, FIG. 9; 785A, FIG. 10); computing a third utilization metric (e.g., 835, FIG. 10) based on a subset of the first utilization metrics (e.g., 815₁, . . . , 815_{M}, FIG. 10) read from the overheads of the subset (e.g., 805) of the first digital containers; and transmitting the third utilization metric in an overhead of the HO digital container (e.g., 785A, FIGS. 9, 10) encapsulating the subset of the first digital containers.

In any of the above implementations, obtaining the at least one first utilization metric may comprise performing resource usage measurements at the first NE (e.g. 80a, FIG. 2; 200, FIG. 4; 700, FIG. 9). In some implementations, performing the resource usage measurements at the first NE may comprise measuring at least one of: a data rate of the at least one input data stream, electrical power usage at the first NE, or processor memory usage at the first NE. The first utilization metric may comprise an estimate of a resource provided by the first NE to process the at least one input data stream.

In any of the above implementations, the method may include periodically measuring a data rate of the at least one input data stream to obtain a stream data rate metric. In some implementations, the method may further comprise computing a ratio of the stream data rate metric to a data rate capacity of a port (e.g., 81₁ or 81₂, FIG. 2; 211₁, . . . , or 211_{N}, FIG. 4) receiving the at least one input data stream to estimate the first utilization metric.

In any of the above implementations of the method, the optical network may be a connection-switched optical network (e.g., 85, FIG. 2), and the method may comprise collecting, by the NMS, a plurality of first utilization metrics from a plurality of NEs (e.g., 80A, 80f, and 80c, FIG. 2) of the optical network to estimate end-to-end utilization of the resource by the at least one input data stream (e.g., 71, FIG. 2).

A related aspect of the present disclosure provides a system comprising a first NE (e.g., 80a, FIG. 2; 200, FIG. 4; 700, FIG. 9) of an optical network (e.g., 85, FIG. 2). The first NE comprises a first interface (e.g., 81, FIG. 2; 210, FIG. 4) configured to receive at least one input data stream (e.g., 71 and/or 72, FIG. 2; 101, FIG. 3; 201₁, . . . , 201_{N}, FIG. 4), a second interface (e.g., 83, FIG. 2; 250, FIG. 4) configured to transmit an output data stream (e.g., 241, FIG. 4) over an optical channel, the output data stream comprising the at least one input data stream, and digital hardware (e.g., 1020 and/or 1030, FIG. 11) configured to obtain at least one first utilization metric (e.g., 115, FIG. 3; 315₁, . . . , 315ₙ, FIG. 5) for the at least one input data stream. The first NE is configured to transmit the at least one first utilization metric to at least one of an NMS (e.g., 99, FIG. 2; 270, FIGS. 4, 9) of the optical network or the second NE (e.g., 80f, FIG. 2).

In some implementations, the digital hardware may be configured to perform measurements of a resource to obtain the at least one first utilization metric. In some implementations, the digital hardware may receive the at least one first utilization metric with the at least one input data stream (e.g., 71 or 72, FIG. 2; 101, FIG. 3; 201₁, . . . , 201_{N}, FIG. 4). In some implementations, the digital hardware may generate the at least one first utilization metric based on a pre-defined policy.

In any of the above implementations of the system, the first NE may be configured to transmit the at least one first utilization metric comprised in a least one first digital container (e.g., 214₁, . . . , 214_{N}, FIGS. 4, 5; 510, FIG. 7A) encapsulating the at least one input data stream.

In any of the above implementations of the system, the at least one input data stream may comprise a plurality of input data streams, the output data stream may comprise an aggregation of the plurality of input data streams (e.g., 201₁, . . . , 201_{N}, FIG. 4), and the at least one first utilization metric may comprise a plurality of first utilization metrics (e.g., 315₁, . . . , 315ₙ, FIG. 5) corresponding to the plurality of input data streams. The first NE may be configured to transmit the plurality of first utilization metrics in overheads (e.g., 400, FIG. 6B; 520, FIG. 7A) of first digital containers (e.g., 510, FIG. 7A; 510₁, . . . , 510_{N}, FIG. 7B) encapsulating corresponding ones of the plurality of input data streams. In any such implementation, the system may comprise the second NE (e.g., 80f, FIG. 2; 700, FIG. 9). The second NE may be configured to receive the output data stream of the first NE over the optical channel, to demultiplex a subset (e.g., 805, FIG. 10) of the first digital containers from the output data stream received from the first NE, and to encapsulate the subset of the first digital containers into a higher-order (HO) digital container (e.g., 785A, FIGS. 9, 10) for transmitting to a third NE (e.g., 80c of 80d, FIG. 2) of the optical network. The second NE may further comprise digital hardware (e.g., 760, FIG. 9; 1020 and/or 1030, FIG. 11) configured to compute a third utilization metric (e.g., 835, FIG. 10) based on those of the first utilization metrics (e.g., 815₁, . . . , 815_{M}, FIG. 10) transmitted in the overheads of the first digital containers (e.g., 805₁, . . . , 805_{M}, FIG. 10) of the subset, and to transmit the third utilization metric in an overhead of the HO digital container encapsulating the subset of the first digital containers.

In any of the above implementations, the digital hardware of the first NE may further be configured to compute, based at least in part on the at least one first utilization metric, a second utilization metric (e.g., 135, FIG. 3; 335, FIG. 5) for the output data stream, and to transmit the second utilization metric to at least one of the NMS and the second NE. In any such implementation, the first NE may be configured to transmit the second utilization metric in an overhead of a higher-order (HO) digital container (e.g., 244, FIGS. 4, 5) encapsulating the at least one first digital container.

In any of the above implementations, the digital hardware may be configured to perform measurements of a resource to obtain the at least one first utilization metric.

In any of the above implementations the first interface may comprise at least one port (e.g., 81₁ or 81₂, FIG. 2; 211₁, . . . , or 211_{N}, FIG. 4) for receiving the at least one input data stream. The digital hardware may be configured to perform data rate measurements on the at least one input data stream to obtain the at least one first utilization metric, the at least one first utilization metric being a measure of utilization of a data rate capacity of the at least one port by the at least one input data stream.

In any of the above implementations, the at least one first utilization metric may comprise a ratio of a measure of a data rate of the at least one input data stream to a data rate capacity of a port of the first interface.

An aspect of the present disclosure provides an optical network comprising a plurality of network elements (NEs) (e.g., 80a-80f, FIG. 2) interconnected by optical fiber links, and a network management system (NMS) (e.g., 99, FIG. 2; 270, FIGS. 4, 9) configured to communicate with the NEs over a data communication network (DCN) (e.g., 280, FIGS. 4, 9). At least some of the plurality of NEs are configured to perform measurements of a NE resource to estimate utilization of the NE resource by data streams being received and/or transmitted by said NEs to provide an end-to-end connection in the optical network to support a service, and to generate corresponding utilization metrics. The NMS is configured to use the utilization metrics generated at the at least some of the plurality of NEs to estimate an end-to-end utilization of a network resource by the service.

While the present invention has been particularly shown and described with reference to example embodiments as illustrated in the drawing, it will be understood by one skilled in the art that various changes in detail may be affected therein without departing from the spirit and scope of the invention as defined by the claims.

We claim:

1. A method for an optical network, the method comprising:
receiving, by a first network element (NE) of the optical network, at least one input data stream;
obtaining, by the first NE, at least one first utilization metric for utilization of a resource by the at least one input data stream;
transmitting an output data stream from the first NE to a second NE of the optical network over an optical channel, the output data stream comprising the at least one input data stream; and
transmitting, from the first NE, the at least one first utilization metric to at least one of a network management system (NMS) of the optical network or the second NE.

2. The method of claim 1 comprising transmitting, from the first NE, the at least one first utilization metric in an overhead of at least one first digital container encapsulating the at least one input data stream.

3. The method of claim 1, comprising computing a second utilization metric for the output data stream based at least in part on the at least one first utilization metric, and transmitting the second utilization metric to at least one of the NMS of the optical network or the second NE.

4. The method of claim 3, comprising transmitting the at least one first utilization metric in an overhead of at least one first digital container encapsulating the at least one input data stream and transmitting the second utilization metric in an overhead of a higher-order (HO) digital container encapsulating the at least one first digital container.

5. The method of claim 1, wherein the at least one input data stream comprises a plurality of input data streams, the output data stream comprises the plurality of input data streams, and the at least one first utilization metric comprises a plurality of first utilization metrics corresponding to respective ones of the plurality of input data streams; and
wherein the method further comprises transmitting, from the first NE, the plurality of first utilization metrics over the optical channel in overheads of first digital containers, said first digital containers encapsulating corresponding ones of the plurality of input data streams.

6. The method of claim 5 comprising computing a second utilization metric based on the plurality of first utilization metrics, the method further comprising transmitting the second utilization metric in an overhead of a higher-order (HO) digital container encapsulating the first digital containers.

7. The method of claim 6 further comprising:
encapsulating, at the second NE, a subset of the first digital containers received over the optical channel from the first NE into another higher-order (HO) digital container for transmitting to a third NE of the optical network;
computing a third utilization metric based on a subset of the first utilization metrics read from the overheads of the subset of the first digital containers; and
transmitting the third utilization metric in an overhead of the another HO digital container encapsulating the subset of the first digital containers.

8. The method of claim 1, wherein obtaining the at least one first utilization metric comprises performing resource usage measurements at the first NE.

9. The method of claim 8, wherein performing the resource usage measurements at the first NE comprises measuring at least one of: a data rate of the at least one input data stream, electrical power usage at the first NE, or processor memory usage at the first NE, and wherein the first utilization metric comprises an estimate of a resource provided by the first NE to process the at least one input data stream.

10. The method of claim 8, wherein performing the resource usage measurements comprises measuring a data rate of the at least one input data stream to obtain a data rate metric.

11. The method of claim 10, wherein the first NE includes a first interface comprising at least one port for receiving the at least one input data stream, the method further comprising computing a ratio of the data rate metric to a data rate capacity of the at least one port to estimate the first utilization metric.

12. The method of claim 1, wherein the optical network is a connection-switched optical network, the method comprising collecting, by the NMS, a plurality of first utilization metrics from a plurality of NEs of the optical network to estimate end-to-end utilization of the resource by the at least one input data stream.

13. A system, comprising:
a first network element (NE) of an optical network, the first NE comprising:
a first interface configured to receive at least one input data stream;
a second interface configured to transmit an output data stream over an optical channel, the output data stream comprising the at least one input data stream; and
digital hardware configured to obtain at least one first utilization metric for utilization of a resource by the at least one input data stream; and
wherein the first NE is further configured to transmit the at least one first utilization metric to at least one of a network management system (NMS) of the optical network or a second NE of the optical network.

14. The system of claim 13, wherein the at least one input data stream comprises a plurality of input data streams, the output data stream comprises an aggregation of the plurality of input data streams, the at least one first utilization metric comprises a plurality of first utilization metrics obtained for the plurality of input data streams, and
wherein the first NE is configured to transmit the plurality of first utilization metrics in overheads of first digital containers encapsulating corresponding ones of the plurality of input data streams.

15. The system of claim 14, wherein the digital hardware of the first NE is further configured to compute, based at least in part on the plurality of first utilization metrics, a second utilization metric for the output data stream; and
wherein the first NE is further configured to transmit the second utilization metric to at least one of the NMS or the second NE.

16. The system of claim 15, wherein the first NE is configured to transmit the second utilization metric in an overhead of a higher-order (HO) digital container encapsulating an aggregate of the first digital containers.

17. The system of claim 13, wherein the digital hardware is configured to perform measurements of the resource to obtain the at least one first utilization metric.

18. The system of claim 13, wherein the first interface comprises at least one port for receiving the at least one input data stream, and wherein the digital hardware is configured to perform data rate measurements on the at least one input data stream to obtain the at least one first utilization metric, the at least one first utilization metric being a measure of utilization of a data rate capacity of the at least one port by the at least one input data stream.

19. The system of claim 14, wherein the second NE is configured to receive the output data stream of the first NE over the optical channel, to demultiplex a subset of the first digital containers from the output data stream received from the first NE, and to encapsulate the demultiplexed subset of the first digital containers into a higher-order (HO) digital container for transmitting to a third NE of the optical network; and
wherein the second NE comprises digital hardware configured to compute a third utilization metric based on first utilization metrics transmitted in overheads of the demultiplexed subset of first digital containers, and to transmit the third utilization metric in an overhead of the HO digital container encapsulating the demultiplexed subset of the first digital containers.

20. An optical network comprising:
a plurality of network elements (NEs) interconnected by optical fiber links; and,
a network management system (NMS) configured to communicate with the plurality of NEs over a data communication network (DCN);
wherein at least some of the plurality of NEs are configured to perform measurements of a NE resource to estimate utilization of the NE resource by input data streams being received and/or transmitted by said NEs to provide an end-to-end connection in the optical network to support a service, and to generate corresponding utilization metrics;
and wherein the NMS is configured to use the utilization metrics generated by the at least some of the plurality of NEs to estimate an end-to-end utilization of a network resource by the service.
